(19) United States
(12) Patent Application Publication
(10) Pub. No.: US 2015/0220965 A1
(43) Pub. Date: Aug. 6, 2015

(54) METHOD FOR GENERATING, DISTRIBUTING, and REDEEMING ELECTRONIC COUPONS

(71) Applicant: Tech Fusion Corporation, Huntington Beach, CA (US)

(72) Inventors: William Sullivan, Huntington Beach, CA (US); Dale Hachiya, Huntington Beach, CA (US); Sean LeMons, Stanton, CA (US)

(21) Appl. No.: 14/616,733

(22) Filed: Feb. 8, 2015

Related U.S. Application Data
(63) Continuation-in-part of application No. 14/522,424, filed on Oct. 23, 2014.
(60) Provisional application No. 61/802,032, filed on Mar. 15, 2013.

(51) Int. Cl. G06Q 30/02

(52) U.S. Cl. CPC G06Q 30/0238

(57) ABSTRACT

A method is provided for offering and distributing digital coupons from promoters to users via a network. The method includes the steps of receiving the digital coupons, storing them on a central computer, and associating them with a product identifier. The user selects a selected product identifier, and the digital coupons associated with the selected product identifier are then transmitted to the user, who can then select a selected digital coupon, for use. Data regarding selection of and redemption of the digital coupons is reported in real time or near-real-time, so that a promoter is able to track the results generated by their digital coupons, track the results achieved by competitors, and dynamically adjust the value and other terms of their digital coupons. The promoter pays a fee for the placement of and/or redemption of each of the digital coupons.

### CROSS-REFERENCE TO RELATED APPLICATIONS

This application for a utility patent is a continuation-in-part of a previously filed utility patent, still pending, having the application Ser. No. 14/522,424 filed Oct. 23, 2014.

This application for a utility patent also claims the benefit of U.S. Provisional Application No. 61/802,032, filed Mar. 15, 2013.

### BACKGROUND OF THE INVENTION

1. Field of the Invention

This invention relates generally to coupon distribution methods and systems, and more particularly to a method for generating, distributing, and redeeming electronic coupons that provides real time or near-real-time data to promoters using the system, so that dynamic adjustment of the coupons may be made to maximize return on investment in the digital coupons.

2. Description of Related Art

Various patents and patent applications teach similar coupon delivery and redemption systems. Examples of such patents and applications include the following:

Sloan, U.S. Pat. No. 5,918,211, teaches a scanner device that is provided to shoppers, for scanning bar codes of products to receive special offers, coupons, etc., related to the product scanned. The specially designed device is in constant wireless communication with the store (and/or retailer/manufacturer computers). The scanner may also receive information about a loyalty program, so that the shopper's history may be used to offer additional coupons that might be available at that time.

Elhaoussine et al., U.S. 2003/0004808, teaches a coupon system that utilizes a mobile phone to scan a product for selecting suitable coupons. The selected coupons are stored in the mobile phone, and then transmitted to a payment terminal via an operable wireless connection, such as Bluetooth®. A list of products purchased is compared with the list of coupons to confirm that the necessary products were purchased, to then enable deduction of the coupon amounts.

Shaer, U.S. 2010/0268592, teaches a coupon system that also utilizes a mobile phone to scan a product to retrieve a coupon or other promotional, which is stored in a phone database. The system also teaches sending an alert to the mobile phone alerting the user to a promotion for a related product, which is stored in the phone for later communication to the payment terminal. The phone may communicate with the payment terminal with a wired connection, a wireless connection, or by generating bar codes for the coupons, which may be scanned in the same way paper coupons are scanned.

Other similar systems have been described in other recent patent applications, including: Ow, U.S. 2012/0303440, Head, U.S. 2008/0010114, and Pearlman, U.S. 2003/0233276. All of the above-described references are hereby incorporated by reference in full.

There is a long-felt need in the industry for a coupon distribution method that provides real time or near-real-time data to promoters using the system, so that dynamic adjustment of the coupons may be made to maximize return on investment in the digital coupons.

The prior art does not teach such a system. The prior art also does not teach a method for distributing electronic coupons that enables placement or electronic coupons on a coupon network that may be accessed by portable electronic devices so that shoppers may access a variety of related coupons associated with a product. The present invention fulfills these needs and provides further advantages as described in the following summary.

### SUMMARY OF THE INVENTION

The present invention teaches certain benefits in construction and use which give rise to the objectives described below.

The present invention provides a method for offering and distributing digital coupons from promoters to users via a network. The method includes the steps of receiving the digital coupons, storing them on a central computer, and associating them with a product identifier. The user selects a selected product identifier, and the digital coupons associated with the selected product identifier are then transmitted to the user, who can then select a selected digital coupon, for use. Data regarding selection of and redemption of the digital coupons is reported in real time or near-real-time, so that a promoter is able to dynamically adjust the value of the digital coupon. The promoter pays a fee for the placement of and/or redemption of each of the digital coupons.

A primary objective of the present invention is to provide a method for offering and distributing digital coupons, the method having advantages not taught by the prior art.

Another objective is to provide a coupon distribution method that provides real time or near-real-time data to promoters using the system, so that dynamic adjustment of the coupons may be made to maximize return on investment in the digital coupons.

Another objective is to provide a coupon distribution method that enables placement of coupons associated with a product in a manner that is easy for a user to review the coupons and make selections at the time of purchase, and then quickly and easily use the coupons.

Another objective is to provide a coupon distribution method that enables placement of a additional coupons that are related to the product, for competing products, and/or products that are related to the product selected by the user.

Another objective is to collect live shopper data relative to the choice or choices made once the primary product is scanned, an offer is presented (if available), and alternative offers for similar or competitive products are presented (if available) to the shopper at the same time. The prior art does not teach the collection of and dissemination of this form of unique data and presentation.

A further objective is to provide a coupon distribution method that can integrate with loyalty programs already offered by stores, that is easy to use, and that does not require a user to utilize a specialty electronic device.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a portable electronic device having a shopper app installed thereupon for scanning a product, according to one embodiment of the present invention;

FIG. 2 is a block diagram of the operable components of the portable electronic device of FIG. 1;

FIG. 3 is a block diagram of a coupon system that includes the portable electronic device of FIGS. 1 and 2, used in conjunction with a central computer having a master coupon program and an ad placement program, and a store computer that includes a POS computer having a scanner;

FIG. 4 is a flow diagram of a method of receiving a coupon from a manufacturer at a given price per click or impression;

FIG. 5 is a flow diagram illustrating the operation of the coupon system to display available coupons to the user via the master coupon program and the shopper app;

FIG. 6 is a flow diagram illustrating the transmittal of selected coupons from the user during checkout;

FIG. 7 is a front elevational view of a portable electronic device generating a bar code to transmit one of the selected coupons to the POS computer of FIG. 3;

FIG. 8 is a front elevational view of the portable electronic device generating a QR code to transmit all of the selected coupons to the POS computer;

FIG. 9 is a perspective view of a portable electronic device, illustrating a graphic user interface generated by the shopper app for displaying in-store specials; and

FIG. 10 is a screen capture of one embodiment of a screen generated by the ad placement program, for receiving information about the electronic coupon to be offered by the promoter.

### DETAILED DESCRIPTION OF THE INVENTION

The above-described drawing figures illustrate the invention, a coupon system 10 and method for receiving coupons for products 12 from promoters via a network 16, distributing the coupons to users via the network 16, and redeeming the coupons at checkout. The coupon system 10 delivers the coupons to a computer device of the user, typically a portable electronic device 20 such as a smart phone, tablet computer, or similar electronic device, although alternative devices may be used in alternative embodiments of the invention.

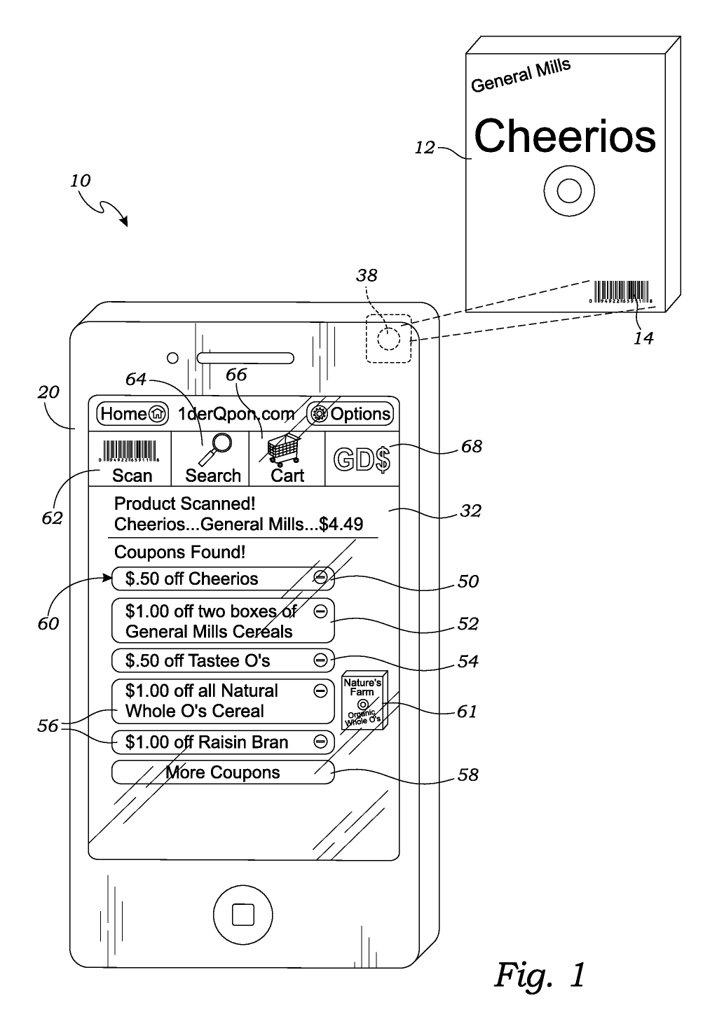

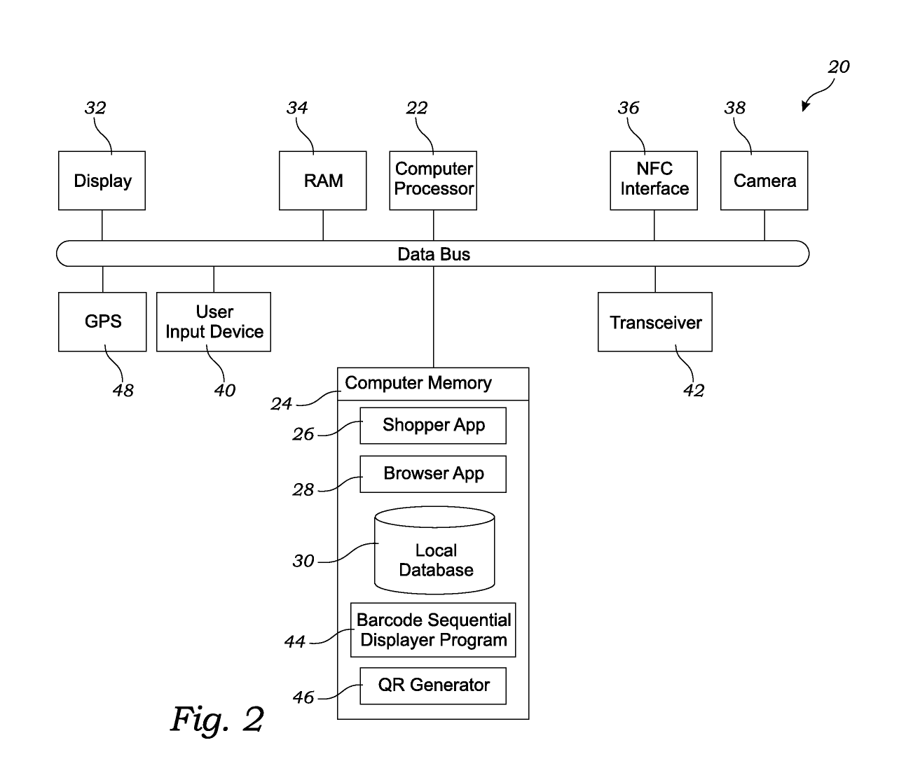

FIG. 1 is a perspective view of one embodiment of the portable electronic device 20 being utilized with the coupon system 10. FIG. 2 is a block diagram of the operable components of the portable electronic device 20 of FIG. 1. As illustrated in FIGS. 1-2, the portable electronic device 20 of this embodiment is a smart phone that includes a shopper app 26 installed thereupon. The shopper app 26, or “application,” is a program that may be downloaded and installed using methods known in the art. The shopper app 26 enables the user to select a product 12, as illustrated in FIG. 1, and to communicate with the coupon system 10 as described in greater detail below to find coupons for the product 12, or related products.

As illustrated in FIG. 2, the portable electronic device 20 may include various electronic components known in the art for this type of device. In this embodiment, the portable electronic device 20 may include a computer processor 22, a computer memory 24, a display 32, RAM 34, an NFC interface 36, a camera 38, a user input device 40 (e.g., touch screen, keyboard, and/or other form of input device known in the art), and a transceiver 42 for wireless communication. For purposes of this application, the term “transceiver” is defined to include any form of transmitter and/or receiver known in the art, for cellular, WIFI, radio, and/or other form of wireless communication known in the art. A global positioning system (“GPS”) 48 may also be included, as is known in the art of these types of portable electronic devices 20. Obviously, these elements may vary, or may include alternatives known in the art, and such alternative embodiments should be considered within the scope of the claimed invention.

As illustrated in FIG. 2, the computer memory 24 of the portable electronic device 20 may be used to download software applications, or “apps,” to extend the utility of the portable electronic device 20. In this case, the computer memory 24 of the portable electronic device 20 receives the shopper app 26 and/or a browser app 28 for browsing web pages that may include additional coupon options. A local database 30 may be included for receiving and storing data temporarily, such as selected coupons, and information about the user; however, this is not required, and all data may be retained in another location if desired. Additional programs may also be included, including but not limited to a bar code sequential display program 44 and/or a QR generator program 46, both of which are discussed in greater detail below.

In the embodiment of FIGS. 1 and 2, the shopper app 26 of FIG. 2 may be used to generate a graphic user interface 60 on the display 32 of the portable electronic device 20, as illustrated in FIG. 1, to enable the user to interact with the shopper app 26. In this embodiment, the graphic user interface 60 may be used to select a product identifier of the product 12 that the user is interested in purchasing, to determine if there are any related coupons. For purposes of this application, the selection of the product identifier includes the selection of at least one or more product identifier(s), and any number may be selected using any methods known in the art.

In the present embodiment, the graphic user interface 60 include a scan button 62. When the user presses the scan button 62, the camera 38 is used to capture an image of a bar code 14 of the product 12. This image is then used to determine the product identifier of the product 12, in this case a universal product code (“UPC”) of the product 12. In alternative embodiments, the product identifier of the product 12 may be entered or determined using any techniques known in the art, such as manually typing in the UPC, a description of the product 12, or by selecting a product 12 from menu options (via a search button 64 in the illustrated embodiment). In another embodiment, speech recognition may be used, or other methods known in the art. The terms “universal product code” and “UPC” are hereby defined to include any equivalent identification system or code that may be utilized to identify the product 12.

The graphic user interface 60 may also include a cart button 66, and an in-store special button 68, both of which are described in greater detail below. The in-store special button 68 may be used to access a list of in-store specials, as discussed below. The graphic user interface 60 may also provide coupons, in text and/or graphic form, as discussed below, for selection by the user.

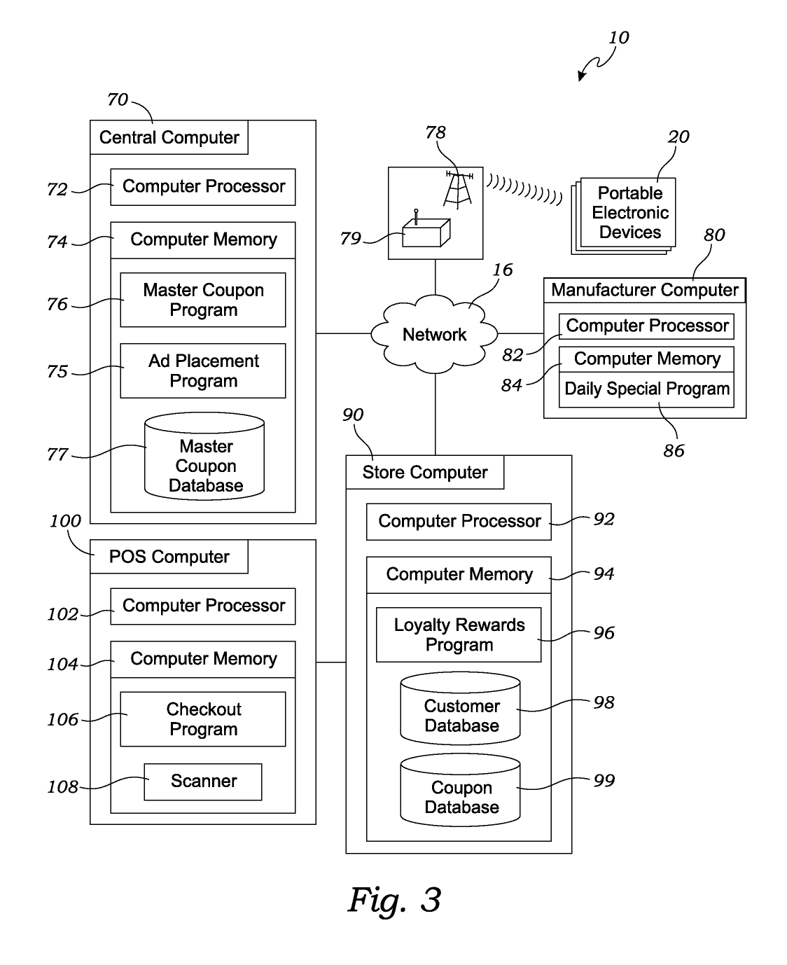

The shopper app 26 of FIG. 2 enables communication with a central computer 70 (illustrated in FIG. 3) to receive available coupons for or related to the product 12 selected. In this embodiment, the display 32 may be used for offering the available coupons to the user. In the illustrated embodiment, the display 32 shows a first coupon 50 for the product 12, a second coupon 52 for the product 12 and a second product, a third coupon 54 for a competing brand of the product, and additional coupons 56 for related products (in this case, other varieties of cereals). For purposes of this application, the term “coupon” includes the terms of any form of discount, promotion, or special offer, such as are known in the art. The coupon may be a digital coupon that includes a certain discount for every item purchased, and may include a term (e.g., having an expiration date), and/or other requirements for redemption (e.g., purchasing a certain quantity of the product).

A “more coupons” button 58 may be included to allow the user to page through additional options (or alternatively, a scroll function, not shown, could be used, or other equivalent functions known in the art). Merely pressing on one of these buttons enables the user to select a coupon that he or she would like to use. Upon checkout, as described below, the user will receive the discount from the selected coupon.

In the present embodiment, the coupon may further include a graphic image 60 of the product 12 or a related product, a logo related to the product, or other graphic design element to draw attention to the associated coupon. The graphic image 60 is one type of option that might be offered for a higher placement price, as discussed below in greater detail. While one embodiment of the shopper app 26 is illustrated herein, those skilled in the art will recognize that alternative systems and methods may be used consistent with the teachings of this invention, and such alternatives should be considered within the scope of the present invention.

FIG. 3 is a block diagram of the coupon system 10 that includes the portable electronic device 20 of FIGS. 1 and 2, used in conjunction with a central computer 70. The coupon system 10 may interact, in some embodiments, with a manufacturer computer 80 to receiving coupons for placement. The coupon system may also interact with a store computer 90, so that the coupon system 10 can interact with a POS computer 100 during checkout. These options are discussed in greater detail below.

As illustrated in FIG. 3, the central computer 70 includes a computer processor 72 and a computer memory 74, such as is well known in the art. As used throughout this application, the terms computer, computer processor, computer memory, and other computer related components, are hereby expressly defined to include any arrangement of computer(s), processor(s), memory device or devices, and/or computer components, either as a single unit or operably connected and/or networked across multiple computers (or distributed computer components), to perform the functions described herein. Those skilled in the art will recognize that different functions may be performed on physically different computers, or all on a single computer, and the various components may be present in different numbers and different forms, and all such alternative arrangements known in the art should be considered within the scope of the present invention.

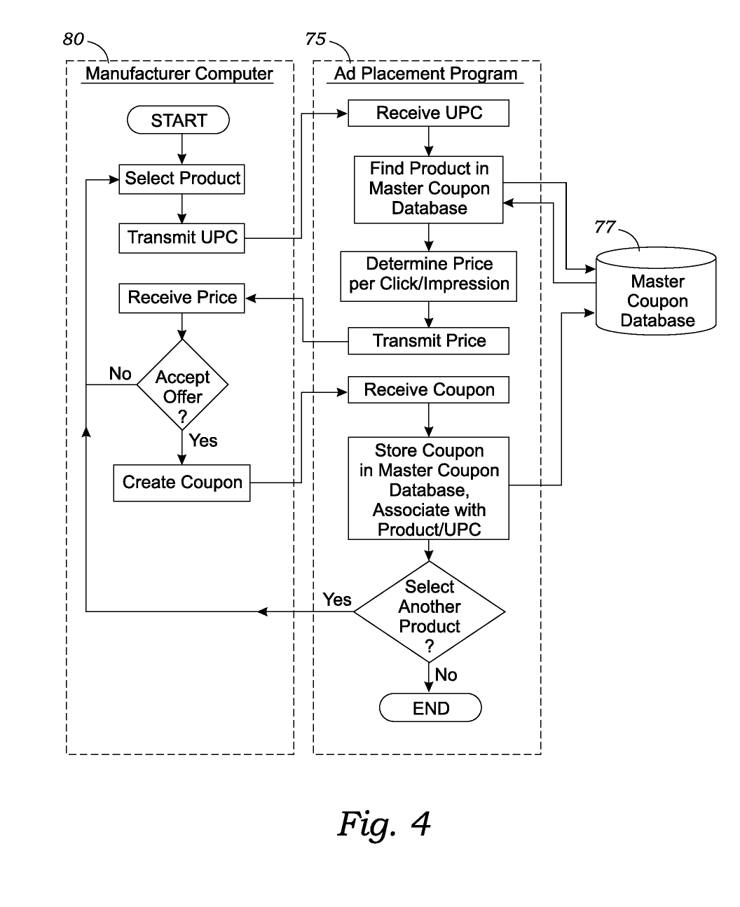

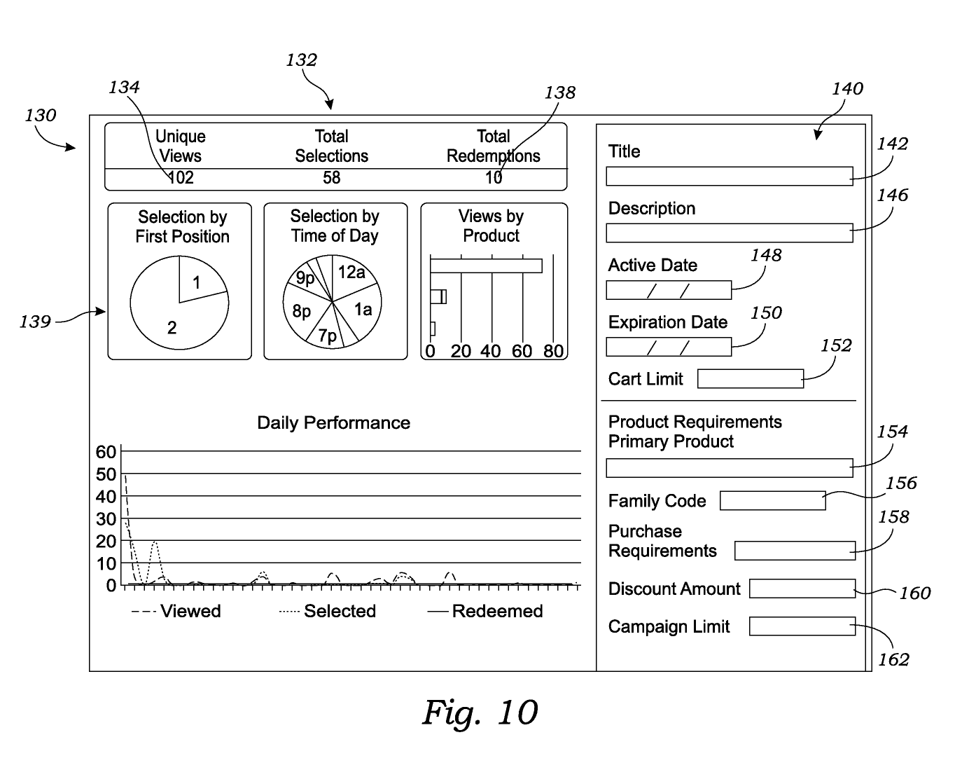

As illustrated in FIG. 3, an ad placement program 75 may be operably installed in the computer memory 74 of the central computer 70, and enables promoters such as manufacturers, distributors, retailers, and other interested parties to arrange placement of coupons in the coupon system 10. While a single program is illustrated on a single computer, as noted above, the program may be broken into multiple components installed on different computers, and this alternative is expressly considered within the definition of the terms as discussed above. The operation of one embodiment of the ad placement program 75 is illustrated in FIG. 4, and discussed in greater detail below. An example of a screen capture generated by the ad placement program 75 is illustrated in FIG. 10.

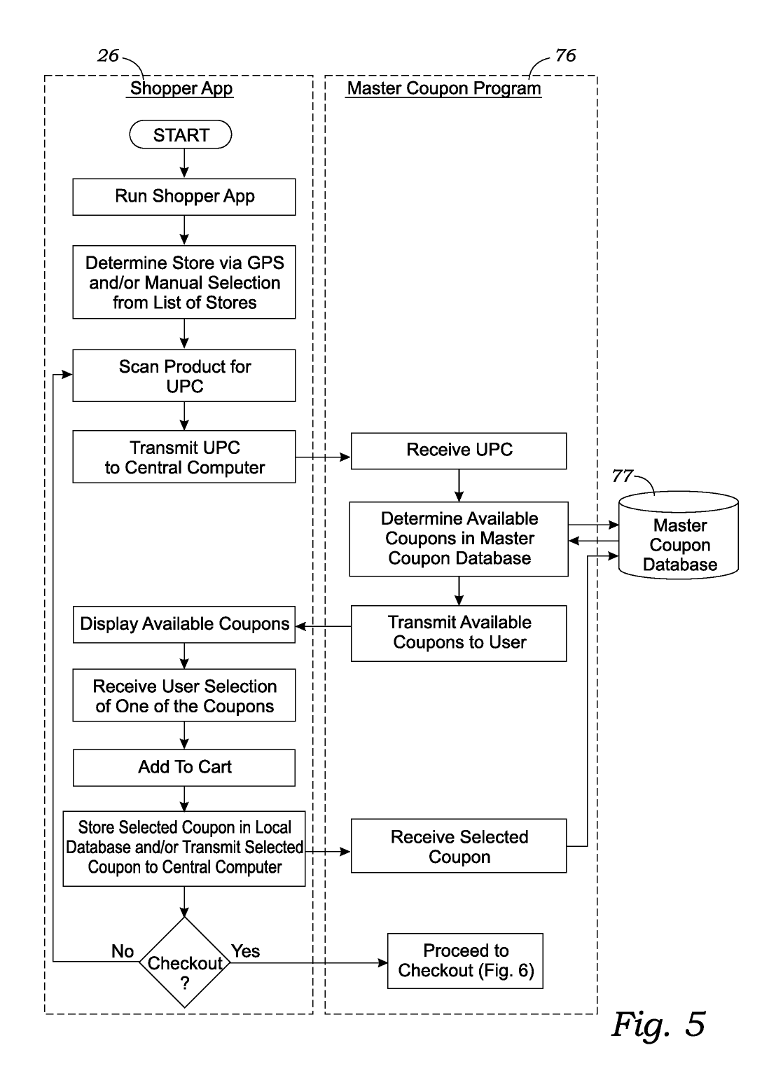

As illustrated in FIG. 3, a master coupon program 76 is operably installed in the computer memory 74 of the central computer 70, and controls the operation of the coupon system 10. The master coupon program 76 may function in conjunction with a master coupon database 77, which functions to store the necessary data, and associate the data as discussed herein. While a single program is illustrated on a single computer, as noted above, the program may be broken into multiple components installed on different computers, and this alternative is expressly considered within the definition of the terms as discussed above. The operation of one embodiment of the master coupon program 76 is illustrated in FIG. 5, and discussed in greater detail below.

The portable electronic devices 20 of FIGS. 1-2 may operably communicate with the central computer 70 via the network 16, as illustrated in FIG. 3. While any form of network may be used, in this embodiment the network 16 includes a cell tower 78 or similar network device 79 that may operably communicate with the rest of the network (e.g., the Internet, a private network, or other similar or equivalent network).

A manufacturer computer 80 (similarly having a computer processor 82 and a computer memory 84) may similarly enter into such communication with the central computer 70 via the network 16, using any systems and methods known in the art, for creating coupons, as illustrated in FIGS. 4 and 10, and as discussed below. Since this operative communication is well known in the art, it is not described in greater detail herein.

The manufacturer computer 80 may be used by the manufacturer to access the computer system 10 for adding coupons and otherwise participating and interacting with the system 10, as discussed in more detail herein. The manufacturer computer 80 may also include downloaded programs (apps) for various types of interaction with the system 10. For example, the manufacturer computer 80 may include a daily special program 86 that may be used to create and maintain a daily special on the system 10.

The daily special may include a special minimum coupon offer that is always available for a range of products (e.g., all KRAFT® products, all of a certain type of product, etc.). These general coupon offers may be subject to certain minimums or other standards and/or limitations, and may be offered to only certain target demographics, or to all consumers.

These minimum coupon offers may be automatically downloaded to all portable electronic devices 20, and may thus be made always available, regardless of the availability of special offers, and even available for use if there is no network connectivity at the time of purchase. This gives the customer a guaranteed benefit at all times, and thus provides an incentive to always use the coupon system 10, because the consumer will know that a certain minimum benefit will always be available. In case of loss of connectivity with the primary network (e.g., cell phone network, or other), the system 10 may also switch to the use of WiFi or similar local network, to maintain connectivity, even the use of a store WiFi network, or other suitable network.

In the embodiment of FIGS. 1-3, the daily special program 86 interacts with the master coupon program 76, both illustrated in FIG. 3, to download the daily special to the shopper app 26 (of FIG. 2) of the portable electronic devices 20 (of FIG. 3) This daily special may be stored in the local database 30 (of FIG. 2) for extended periods of time, so that a data connection is not required to display this offer to the user.

The shopper app 26 may also function to generate a banner advertisement (not shown) on the display 32 that advertises any forms of coupons, promotions, advertisements, and/or any other information that might be of interest to the users of the system, including but not limited to special rewards point for use of the coupon system 10, randomly generated special coupons, and other similar rewards that encourage the frequent use of the coupon system 10 by the user. Furthermore, it may include a “time of day” coupon that provides a special reward for purchases made at a certain day and/or time of day and/or period of time. Such coupons may be offered by a store, for example, to encourage traffic during slow days and/or times of day, and moderate traffic during peak times. The banner ad of this embodiment displays a coupon that is good only on purchases made during a predetermined time of day.

A store computer 90, having a computer processor 92 and a computer memory 94, may also be connected via the network 16 with the central computer 70, for purposes described in greater detail below. As discussed below, the store computer 90 may include a loyalty rewards program 96 that interacts with the master coupon program 76, for offering special coupons to loyal customers via the coupon system 10, and for providing demographic information about the users of the coupon system 10. The store computer 90 may further include a customer database 98 for tracking the customers in the loyalty program, and a coupon database 99 to track the coupons being offered to the various customers, either using or not using the loyalty program.

As discussed in greater detail below, the store computer 90 will typically have one or more POS computers 100 operatively connected with the store computer 90 for checking out customers of the store. The POS computers 100 may interact with the coupon system 10 in various ways as discussed below. The POS computers 100 each include a computer processor 102 and a computer memory 104. A checkout program 106 may be operatively installed in the computer memory 104 for the store checkout process, and may include a fairly standard program known in the art. The checkout program 106 typically is operatively engaged with a scanner 108 for scanning products, coupons, and the like, during the checkout process. The interaction of these systems with the coupon system 10 is discussed in greater detail below.

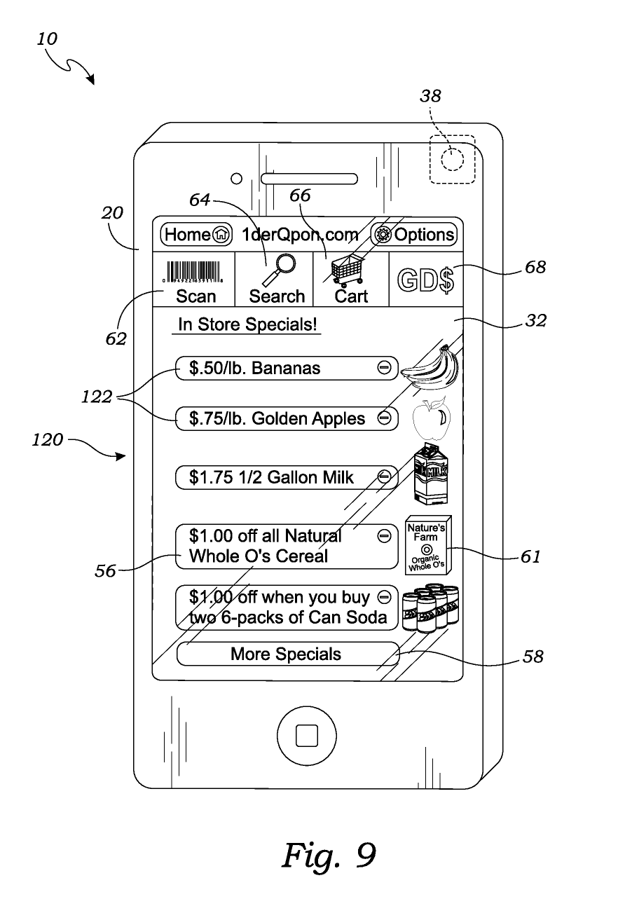

The store computer 90, or other suitable network connection, may be used to participate in the coupon system 10 directly, to interact with the system 10 for upload and download of coupons, and to designate in-store specials, as described in greater detail below with reference to FIG. 9. While certain forms of interaction are described herein, this list is not intended to be exhaustive, but merely illustrative of the potential options made possible by the system 10.

FIG. 4 is a flow diagram of a method of receiving the coupon from a promoter using the ad placement program 75. The promoter may access the coupon system 10 using any method known in the art, in this case from the manufacturer computer 80 illustrated in FIG. 3. The manufacturer computer 80 may be a personal computer, any other form of computer device, smart phone, tablet computer, phone system, or other form of communication network, including through intermediaries such as call center operators, or other methods). The coupon is received for placement in the coupon system 10 at a given price per click or impression (or other method of determining payment known in the art), as described in greater detail below, and illustrated in FIG. 4.

In the embodiment of FIG. 4, the promoter uses the manufacturer computer 80 (defined to include any computer used by any promoter) to select an identified product, such as via the product identifier (e.g., by name, selection from a list, scanning a bar code, or any other method known in the art). The identification of the product, such as with reference to the UPC, is then transmitted to the ad placement program 75 of the central computer 70 (of FIG. 3), for association with the coupon that was uploaded. FIG. 10, discussed below, discussed one embodiment of this submission.

In addition to the identified product, the digital coupon also includes a discount amount (reference number 160 in FIG. 10), which specifies how much of a discount the consumer will receive for redemption of the digital coupon. This may be specified in a dollar amount, a percentage off, or other measure. This may require the purchase of a certain number of the product, and/or the purchase of addition products, as defined by the promoter.

As illustrated in FIG. 4, the ad placement program 75 functions to receive the request from the promoter and the UPC, and find the UPC in the master coupon database 77 to determine a coupon fee that is to be charged for providing the digital coupon. The fee may be a specific amount, a percentage, it may vary based upon the product or the discount amount, or any other method known in the art. The fee may be associated with the product identified with the UPC. The fee may be determined in any other manner; for example, the fee may be set by the operator of the coupon network 10, they may be determined in an auction format, special deals may be negotiated directly with a given promoter, or another method may be used. The price may be determined based upon the retail price of the product, the demand for this particular product, demand from other promoters for placing coupons in association with this product, and/or other factors.

The fee may be based coupon redemptions, and/or on impressions delivered by the coupon system 10, or other systems and methods, as desired by the operator of the coupon system 10. The fees (per click, or per impression, or other) may be fixed prior to any particular transaction, or they may be transmitted to the promoter at the time the digital coupon is generated, and the promoter is then able to accept or reject the offer.

The system may track coupon redemptions, for determining fees based upon the redemption of the coupon. The system may also track the digital coupons that are transmitted to the user but not redeemed. In one embodiment, all coupons that are offered results in a fee, either a flat fee, or a fee based upon the placement of the digital coupon (with higher fees being charged for the top position or two). In another embodiment, fees may be charged for coupon transmission (but not redemption) only if at least one of the coupon transmissions is actually redeemed. A cost per impression due may be determined in response to the transmission of the digital coupons, once confirmation that one of the transmitted coupons was actually redeemed.

The promoter is then prompted to create or otherwise enter (or upload) the coupon (including the terms of the coupon, expiration date, etc.). The coupon is received and stored in a database, such as the master coupon database 77 described above, and associated with the product (e.g., product identifier). When this product is selected by future shoppers, they may be offered the coupon, along with any other competing coupons, for the shopper to review and potentially select.

Obviously, more powerful systems may offer additional options to enable the promoter to more closely control the offerings being made. A given coupon may be offered only in certain stores, certain geographic areas, or to shoppers who meet certain demographic requirements. These any other more powerful options are considered within the scope of the present invention.

FIG. 5 is a flow diagram illustrating the operation of the coupon system 10 to transmit the coupons to the user via the master coupon program 76 and to display the coupons to the user via the shopper app 26. The master coupon program 76 and the shopper app 26 together function to receive data from the portable electronic device 20 of the user (in practice, many users), return the coupons that are suitable for the user, and enable the user to select his or her preferred coupons.

The master coupon program 76 may function to transmit the coupons to the users using the following operations:
i) receiving a selected product identifier (e.g., UPC) from one of the users;
ii) transmitting the coupons associated with the UPC to the user;
iii) receiving a selected coupon from the user;
iv) processing the coupon to provide a discount to the user; and
v) tracking the payment due following the placement of and/or use of each of the coupons, per the price determine in the ad placement program 75, in response to user viewing and/or use of the coupons.

As illustrated in FIG. 5, in this embodiment the user must first download and run the shopper app 26 from the portable electronic device 20 of FIG. 1. The download, installation, and operation of such “apps”, or equivalent systems, utilizes systems and methods that are well known in the art, and are therefore not described in greater detail herein. In alternative embodiments, the user might access the central computer 70 from alternative systems (e.g., a PC, kiosk, etc.), and such alternatives are considered within the scope of the present invention.

In the embodiment of FIG. 5, the user may first identify the store at which he or she will be shopping. This can be determined by a GPS 48 (“global positioning system” shown in FIG. 2) when the shopper is physically located in the store, or by a manual selection process, or any other method known in the art. In some embodiments, this step may not be required, or the store determination may be made in other ways, such as during checkout.

While the user is shopping, he or she may scan a bar code 14 of the product 12 of interest (e.g., via an image capture process using the camera 38 of the mobile electronic device, shown in FIG. 2), to determine a UPC for the product 12. Other methods may also be used, including manually entering the UPC number, or manually selecting the product 12 from a list, or any other method known to those skilled in the art.

As illustrated in FIG. 5, with reference to the computer system 10 of FIG. 3, the UPC is then transmitted to the central computer 70 (of FIG. 3), where it is received by the master coupon program 76, and the UPC is processed to determine if there are any coupons in the master coupon database 77 that are associated with that product 12. In one embodiment, the digital coupons are assigned to particular classes of goods, so that a search for one product will generate coupons for competitive or related products. In another embodiment, the promoter assigns each coupon to classes of products that are deemed suitable.

Any available coupons that are located are then transmitted to the user, where they are displayed for review by the user (e.g., on the display 32 of the mobile electronic device of FIGS. 1-2). While one embodiment of this display 32 is illustrated in FIG. 1, those skilled in the art may devise many alternative methods of displaying the coupons, and such alternative methods should be considered within the scope of the present invention.

The user is then able to select a selected coupon from the list, and add the selected coupon to a shopping cart, or otherwise select the coupon for use. The selected coupon may then be stored in the local database 30 of the mobile electronic device (illustrated in FIG. 2), and/or transmitted to the central computer 70 for storage in the master coupon database 77. The user is then able to continue shopping and selecting new products to scan, or he or she can proceed to checkout.

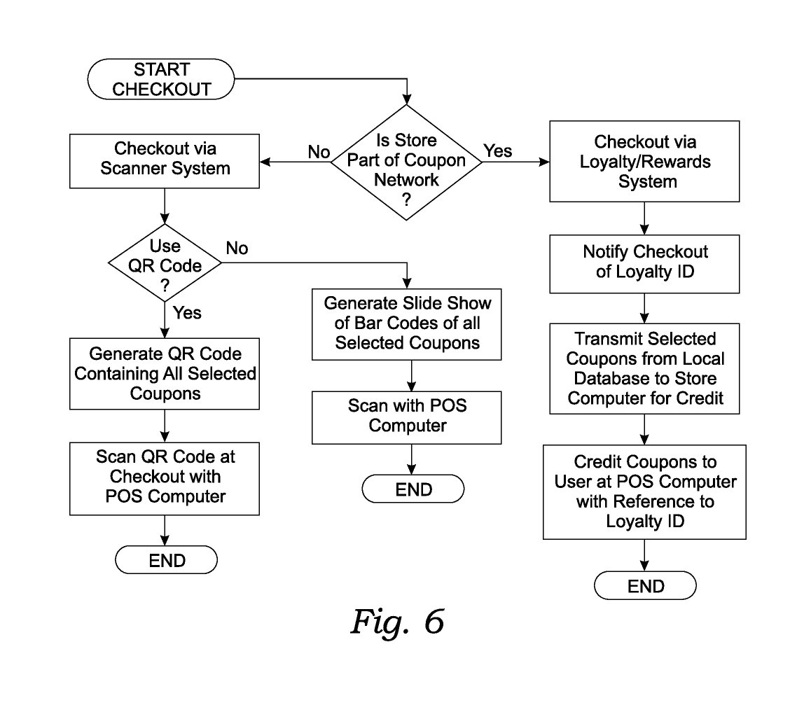

FIG. 6 is a flow diagram illustrating the transmittal of the selected coupons from the user to the POS computer 100 (illustrated in FIG. 3) during checkout. As illustrated in FIGS. 1-3, and 6, when the store is participating member of the coupon system 10, the POS computer 100 is adapted to communicate with the central computer 70, typically through the store computer 90, so that the selected coupons stored in the master coupon database 77 can be sent directly to the store computer 90 for checkout processing. In this embodiment, the user presses the cart button 66 on the portable electronic device 20, as illustrated in FIG. 1, to start the checkout procedure. At that time, he or she also gives his or her loyalty ID to the cashier operating the POS computer 100 (of FIG. 3). The cashier enters the loyalty ID (typically a phone number), or scans a loyalty card (or some equivalent method of communicating the loyalty ID), and this enables the POS computer 100 to receive the selected coupons directly from the central computer 70, and associate them with the correct customer.

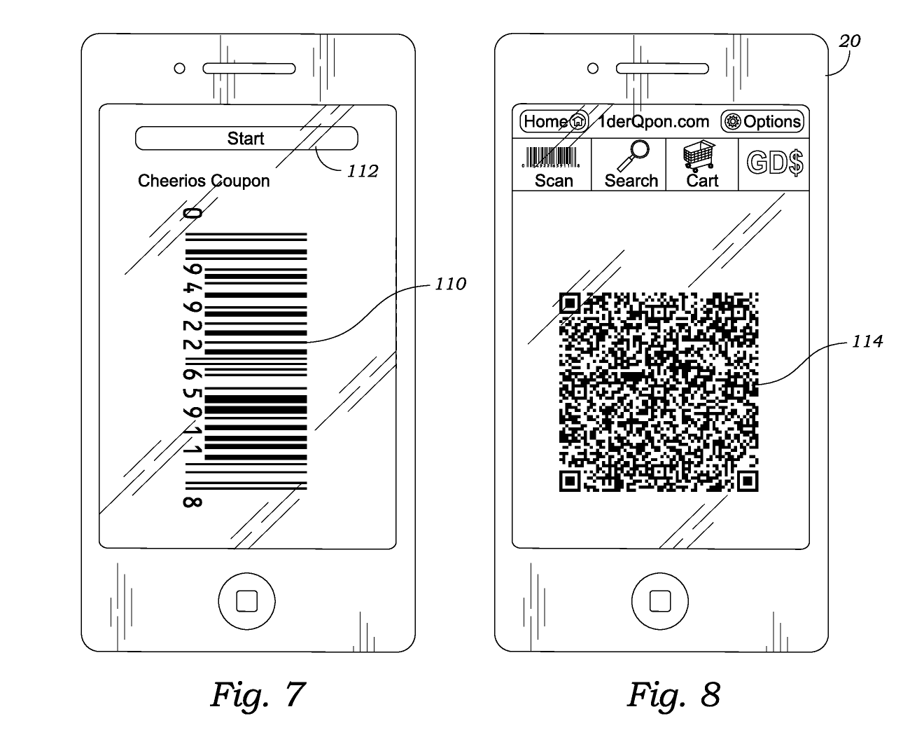

If the store does not participate in the coupon system 10, alternative methods are used to transmit the selected coupons from the local database 30 of the portable electronic device 20 to the POS computer 100 (or the store computer). In one embodiment, the portable electronic device 20 directly communicates with the POS computer 100, via wireless (e.g., Bluetooth®, or similar protocol), or via the NFC interface 36. In another embodiment, the portable electronic device 20 generates bar codes or similar visual indicia that can be scanned with the scanner 108 of the POS computer 100. Two specific embodiments of this approach are discussed below with reference to FIGS. 7 and 8.

FIG. 7 is a front elevational view of a portable electronic device 20 generating a bar code 110 to transmit at least one of the selected coupons to the POS computer 100 (of FIG. 3). In one embodiment, illustrated in FIGS. 1-3 and 7, the portable electronic device 20 further includes a bar code sequential display program 44 operably installed on the computer memory 24 of the portable electronic device 20 that functions to sequentially generate a series of bar codes 110 so that the portable electronic device 20 can be held over the scanner 108 and scan a series of bar codes 110 in one single process. In this embodiment, the portable electronic device 20 generates a “start” button 112 that starts the process, with enough time between each display to allow the scanner 108 to register each of the bar codes 110. This sequential process saves time during the checkout process, so that the POS computer 100 is not occupied to the delay of other shoppers.

FIG. 8 is a front elevational view of the portable electronic device 20 generating a QR code 114 to transmit all of the selected coupons to the POS computer 100. In this embodiment, as illustrated in FIGS. 1-3 and 8, the portable electronic device 20 includes a QR generator program 46 operably installed on the computer memory 24 of the portable electronic device 20 (of FIG. 2). The QR generator program 46 creates a QR code 114 that includes all of the selected coupons in one code, which can then be displayed on the display 32 of the portable electronic device 20 and scanned by the scanner 108 of the POS computer 100 to transfer the selected coupons to the POS computer 100 in one process.

FIG. 9 is a perspective view of the portable electronic device, illustrating a graphic user interface 120 generated by the shopper app 26 for displaying in-store specials 122. As illustrated in FIG. 9, the in-store specials 122 advertise special in-store advertising determined by a store, such as top sales items, and/or a list of daily specials and/or any other form of special offer being offered by the store and/or one or more manufacturers. This gives individual stores the opportunity to publicize special items that they would like to discount for quick movement (e.g., perishable items that do not have much shelf life left, etc.). The in-store specials 122 may also include any other form of promotion that a store manager (or other store management and employees) might want to run. The in-store specials 122 may also offer in-store advertising as part of a loyalty program, or other similar program.

Similarly, the in-store specials 122 (or other suitable section of the display 32) may also include special rewards points, randomly generated special coupons, and other similar rewards that encourage the use of the store's loyalty program by the user.

Method of Use

The invention also include a method of using the coupon system 10, as described above, for receiving coupons for products from promoters via the network, and offering the coupons to users via the network. In this method, the coupons are received by the central computer 70 from the promoters via the network, and the coupons are associated with at least one UPC of the associated product. The coupons are stored in the computer memory of the central computer 70 associated with the at least one UPC. These steps are discussed in greater detail above. In addition to the system described above, additional coupons may also be added from outside databases of available coupons, as well as loyalty program coupons. As used in the present application, the term “coupon” is broadly defined to include any form of coupon, promotion, discount, rebate, and/or similar or equivalent program.

Once the coupons are in the computer memory of the central computer 70, a selected UPC is received from one of the users. The coupons associated with the selected UPC are transmitted to the user, and the user is able to select a selected coupon which is saved to a local database 30 of the portable electronic device 20 and/or to the master coupon database 77 of the central computer 70.

As discussed above, the selected coupons are transmitted from either the local database 30 or the master coupon database 77 to the POS computer 100, at which time the coupon is processed to provide a discount to the user, and payments are made from the coupon issuer to all interested parties, in a manner similar to the prior art coupon systems. Furthermore, a payment due is determined in response to the placement of and/or use of each of the coupons in response to user viewing and/or use of the coupons.

FIG. 10 is a screen capture of one embodiment of a screen 130 generated by the ad placement program 75 (of FIG. 3), for receiving information about the electronic coupon to be offered by the promoter. As illustrated in FIG. 10, the screen 130 displays data 132 about currently active electronic coupons, and may include information such as unique views 134, total selections 136, and coupon redemptions 138. Additional data 139 may be included, in including a wide range of information that may be desired, in either text form, or a wide range of graphs, pie charts, etc.

The data 132 may be used for tracking, in real time, the selection of the selected digital coupons, and other similar data. The data regarding selected electronic coupons should be immediately available, so would typically be available in a matter of seconds, and “real time” is defined to include up to 5 minutes of delay. In some embodiments the data may be delayed for up to a day or two, and still provide a great deal of value to the promoter.

The data 132 may also be used for tracking, in near-real-time, the redemption of the selected digital coupons. Depending upon how the electronic coupons are redeemed, and how quickly the redemption data is reported, this may take anywhere from minutes, to hours, or even days. “Near-real-time” is defined to include delays of 2 days or less. The data is reported as it comes in, in real time and in near-real-time, so that promoters may track the progress of their advertising campaigns. The promoters may then make changes to the discount amounts of the digital coupons, in real time, responsive to the reported data.

As shown in FIG. 10, the screen 130 further includes coupon creation fields 140 for creating the electronic coupons (or modifying existing coupon campaigns). In the present embodiment, the coupon creation fields 140 include a title field 142, a description field 144, an active date 148, an expiration date 150, and a cart limit 152, and may further include any other fields known to those skilled in the art. Furthermore, a product field 154 enables the specification of the identified product (often with a product code such as a UPC), along with other fields, such as a family code 156 and a field for purchase requirements 158. The discount amount may be specified in a discount amount field 160 (i.e., the amount of a discount provided by the coupon, in either a specific amount, or as a percentage). A campaign limit field 162 enables the promoter to specify a total amount that may be spent by the given campaign, which can be specified for all stores, particular stores, etc.

The present system enables a real time, dynamic marketplace, where promoters are able to create, amend, and cancel various coupon campaigns, responsive to actual market data. As data from the system is received, the promoter is able to determine, in real time or in near-real-time, the effectiveness of the campaign, and make adjustments, also in real time. For example, if a given coupon for COKE® is receiving few selections or redemptions,

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A method for offering digital coupons to a user via a network in response to selection of a product identifier by the user, the method comprising the steps of:
receiving the digital coupons via the network, each of the digital coupons having an identified product and a discount amount;
associating each of the digital coupons with at least one associated product identifier;
storing the digital coupons in a computer memory;
receiving the selected product identifier from the user; and
transmitting the digital coupons associated with the selected product identifier to the user so that the user is able to select a selected digital coupon from the associated digital coupons for redemption.

2. The method of claim 1, further comprising the steps of:
tracking data regarding the selection of the selected digital coupons, and regarding the redemption of the selected digital coupons;
reporting the data; and
receiving changes to the discount amounts of the digital coupons responsive to the reported data.

3. The method of claim 1, further comprising the step of determining a cost per click payment due in response to the redemption of the selected digital coupon.

4. The method of claim 1, further comprising the steps of:
tracking, in real time, data regarding the selection of the selected digital coupons;
tracking, in near-real-time, data regarding the redemption of the selected digital coupons;
reporting the data in real time and in near-real-time; and
receiving changes to the discount amounts of the digital coupons, in real time, responsive to the reported data.

5. The method of claim 1, further comprising the steps of:
tracking the digital coupons that are transmitted to the user but not redeemed; and
determining a cost per impression due in response to the transmission of the digital coupons.

6. The method of claim 1, further comprising the step of transmitting a shopper app to the user, the shopper app being adapted to be installed on a portable electronic device for enabling the user to perform the following steps:
selecting the product identifier;
reviewing the digital coupons provided;
selecting the selected digital coupon; and
transmitting the selected digital coupon for redemption.

7. The method of claim 6, wherein the selected digital coupon is transmitted via a UPC code or a QR code generated by the shopper app.

8. The method of claim 1, wherein the product identifier is a universal product code.

9. The method of claim 1, wherein the computer memory is part of a central computer that includes a computer processor, the central computer being operably connected with the network.

10. The method of claim 1, further comprising the step of:
transmitting the selected digital coupon to a POS computer of a store for redemption of the selected digital coupon.

11. A method for offering a digital coupon to users via a network, the method comprising the steps of:
receiving the digital coupon via the network;
storing the digital coupon on a computer memory;
transmitting an offer to associate the digital coupon with a product identifier in exchange for a given payment for placement and/or use of the digital coupon;
receiving an acceptance of the offer;
associating the digital coupon with the product identifier;
storing the association between the digital coupon and the product identifier in a database;
receiving a selected product identifier from one of the users;
transmitting all of the digital coupons associated with the selected product identifier to the user;
receiving a selected digital coupon from the user;
processing the selected digital coupon to provide a discount to the user; and
determining a payment due in response to the placement of and/or use of each of the digital coupons in response to the users viewing and/or selecting the digital coupons, per the accepted offer.

12. The method of claim 11, further comprising the step of transmitting a shopper app to the users, the shopper app being adapted to be installed on a portable electronic device for enabling the user to:
select a product via a product identifier;
review the digital coupons;
select the selected digital coupon; and
transmit the selected digital coupon for redemption.

13. The method of claim 11, wherein the product identifier is a universal product code.

14. The method of claim 11, wherein the computer memory is part of a central computer that includes a computer processor, the central computer being operably connected with the network.

15. The method of claim 14, wherein the database is stored in the computer memory of the central computer.

16. The method of claim 11, further comprising the step of:
transmitting the selected digital coupon to a POS computer of a store for redemption of the selected digital coupon.

17. A method for offering digital coupons to a user via a network in response to selection of a product identifier by the user, the method comprising the steps of:
receiving the digital coupons via the network, each of the digital coupons having an identified product and a discount amount;
associating each of the digital coupons with at least one associated product identifier;
storing the digital coupons in a computer memory;
receiving the selected product identifier from the user;
transmitting the digital coupons associated with the selected product identifier to the user so that the user is able to select a selected digital coupon from the associated digital coupons for redemption; and
providing a shopper app to the user, the shopper app being adapted to be installed on a portable electronic device for enabling the user to perform the following steps:
selecting the product identifier;
reviewing the digital coupons provided;
selecting the selected digital coupon; and
transmitting the selected digital coupon for redemption.

18. The method of claim 17, wherein the selected digital coupon is transmitted to a POS computer via a UPC code or a QR code generated by the shopper app.
